(19) United States
(12) Patent Application Publication
(10) Pub. No.: US 2008/0154510 A1
(43) Pub. Date: Jun. 26, 2008

(54) METHOD AND SYSTEM FOR AUTOMATED CHOKE CONTROL ON A HYDROCARBON PRODUCING WELL

(75) Inventor: Jessie C. Scott, Covington, LA (US)

Correspondence Address: CHEVRON CORPORATION, P.O. BOX 6006, SAN RAMON, CA, 94583-0806, US

(73) Assignee: CHEVRON U.S.A. INC.

(21) Appl. No.: 11/614,813

(22) Filed: Dec. 21, 2006

(51) Int. Cl. G06F 19/00; E21B 43/12

(52) U.S. Cl. 702/12; 166/250.15

(57) ABSTRACT

The present invention includes a method and system for automated choke control on a hydrocarbon producing well. The method includes sensing parameters such as sand production, well head tubing pressure, flow rate through the well system, and pressure differential between downhole tubing and an adjacent producing formation. The opening size of the choke is automatically changed, without need for human intervention, in response to changes in the sensed parameters to optimize operation of the well system. Ideally, a programmable logic controller is used to determine when the opening size on the choke should be changed. An advisory communication is preferably sent to a remotely located monitoring station advising that the opening size of the choke has been automatically adjusted. A decision is then made whether an operator should go to the well site and manually well test and shake out the well before placing the system on automatic operation again. The system includes monitors for monitoring well parameters, an automated choke which works in conjunction with a programmable logic controller to determine when to change the opening size of the choke, independent of human intervention and maintaining flow through the well system, and a notification system to advise a remote located monitoring station that changes have been to the opening size of the choke.

### TECHNICAL FIELD

The present invention relates generally to controlling the operation of a hydrocarbon producing well by opening or closing a choke on a well head of the well, and more particularly, to controlling the choke to prevent damage to the well such as by the influx of sand while optimizing well production.

### BACKGROUND OF THE INVENTION

It is important to control the rate of flow of fluids through a well head on a hydrocarbon-producing well to insure that the well optimally produces without damaging the well. If the fluid flow through well including the well bore, is allowed at too great a flow rate, then sand from a producing formation can invade and damage the well. This occurs, in part, because the pressure differential between the producing formation or formations and the well bore of the well can induce sand to flow into the well bore. Furthermore, a high pressure differential can increase the water cut of the fluids produced from the well, again increasing the likelihood of sand production. This pressure differential can be reduced to slow the incursion of sand into the well bore. A choke, preferably mounted on a well head of the well, can be slightly closed to incrementally increase the resistance to flow through the choke. Consequently, the pressure in the well bore will slightly increase thereby reducing the pressure differential between the producing formation and the well bore and the likely rate of sand incursion.

Excess sand production is undesirable for a number of reasons. First, sand can damage or destroy equipment or piping by abrading surfaces contacted by the flowing sand. The degraded equipment may cause environmental incidents, i.e.—spills or water quality issues. Second, sand is very expensive to clean from equipment and has high disposal fees. Third, damage from sand production can lead to lost production resulting from shutting in wells producing into a particular system, of wells due to cleaning sand from equipment in a production train. Further, well rework costs associated with sand production can be very expensive, including the use of wire lines, coiled tubing or snubbing rework.

If an abnormally large amount of sand is detected by means of a sand probe or sand monitor, which is tied into a pneumatic or SCADA (supervisory control and data acquisition) system, the well may be automatically shut in until it can be safety reopened and closely monitored by the operator white the well is tested and shaken out. A typical well test includes putting the production of the well into an independent test separator to analyze the individual well performance by getting measurements such as tubing pressure, casing pressure, gas rates fluid rates and BS&W (basic sediment and water) measurements. Shaking out a well includes taking a small sample of flowing fluid from a flow line and centrifuging out sand particles to determine the relative production of sand. Often when sand is found in the shake out the choke slightly closed down so a very limited amount of sand is produced.

Production of fluids from a collection of wells may have limits due to the sharing of surface facilities which have limited capacities such as for separating gas, oil and water. The different wells may produce different relative percentages of gas, oil and water. Therefore, production from the individual wells needs to be controlled by adjusting the respective opening size of their chokes. Further, the consequences of slightly opening or closing a choke may not be known for several days as the well bore pressure and fluid flow from producing formations may take several days to stabilize in response to the change in the opening size of the choke.

Determining the optimal opening size of a choke on a well can be complex. Often such decisions: are made by a team of humans, including a reservoir engineer, a production supervisor and an operator. The reservoir engineer typically has good understanding of how the well was drilled and the completions made in the well. The production supervisor generally has a good appreciation of the production history of the well. The operator has the closest day-to-day contact with well and typically physically opens up or closes down the opening size in the choke in consultation with the reservoir engineer and production supervisor. The reservoir engineer and the production supervisor often have many, many wells for which they are responsible leaving very little time to focus on any particular well unless that well has significant production problems.

Factors that this team may take into account in determining how to set the opening size of the choke include; 1) the recent history of the production of sand into the well; 2) the recent pressure in the tubing and/or casing of the well bore; 3) the recent history of the pressure downstream from the choke in flow lines leaving the well; 4) the pressure differential across the choke; 5) the need to accommodate production goals from a number of other wells in a field sharing production facilities; and 6) recent production history of oil, gas and water from the well.

In conventional modes of operation, the team often tracks the above factors via pressure gauges, sand monitors, and flow meters using a SCADA system. At the team's direction, the opening size of the choke is manually increased or decreased to potentially optimize the flow rate in an attempt to keep the well from being damaged, i.e.,—too much sand production or pressure draw down across well bore. This is a time consuming process. Because a reservoir engineer is often responsible for hundreds of wells, many wells are overlooked for potential optimization or go tong periods of time before being optimized due to the number of wells that the reservoir engineer needs to oversee. Similarly, the production supervisor is often overwhelmed by the number of wells for which he or she is responsible. Often the operator may not wish to change the opening size on the choke without consulting with production supervisor and/or reservoir engineer. Accordingly, it may be a month to many months between evaluations of the well to decide if the opening size of the choke should be changed.

FIG. 1 shows a conventional process for well optimization which relies primarily on human management and intervention. A team of experts (reservoir engineer, production supervisor, and operator) will evaluate the performance of a well based on a number of factors such as those described above. The team may determine that the well is operating satisfactorily and not adjust the opening size of the choke for a long period, possibly on the order of months or even up to a year. However, if the team or responsible party determines that choke adjustments are necessary to enhance well production, the operator may increase the size of the opening of the choke. This will allow fluid to more easily pass through the choke and reduces the pressure in the well bore. Consequently, the pressure differential between the well bore and producing formations will also increase as will the potential for increased sand production.

Alternatively, one or more of the team members may decide to reduce the opening size of the choke in instances where a sand probe or sensor indicates that a well is producing too much sand. Or else, the choke may be reduced in opening size if a shake out reveals excessive water or sand production. With the choke opening being reduced, the resistance to flow through the choke is increased. Consequently, the pressure in the well bore increases and the pressure differential with the surrounding production formation is reduced as is the potential for sand production.

When the opening size of the choke is adjusted, the operator typically performs a well test to determine the effect that the changing of the opening size has had on the operation of the well. Often a period of time, such as 48 hours, is provided to allow the well to stabilize after the changing of the opening size of the choke. An evaluation is then again performed to determine whether any further changes to the choke need be made. This, process is continued until a satisfactory opening size for the choke is achieved.

There is a need for a method and system for controlling a chokes on wells which do not suffer from shortcoming associated with conventional well management practices. Such practices of using only manual or human interventions by one or more persons of a team of experts can lead to long periods of time between optimization of the opening size of a choke on a well. Accordingly, wells may operate at a suboptimal level for a considerable period of time resulting in a loss of production. Alternatively, the lack of optimizing the opening size on the choke can lead to enhanced degradation of a well due to undesirable levels of sand production. The present invention addresses this shortcoming in conventional well management practices and systems.

### SUMMARY OF THE INVENTION

The present invention includes a method and system for automated choke control on a hydrocarbon producing well. The method includes sensing parameters such as sand production, well head tubing pressure, flow rate through the well system, and pressure differential between downhole tubing and an adjacent producing formation. The opening size of the choke is automatically changed, without need for human intervention, in response to changes in the sensed parameters to enhance operation of the well system. Ideally, a programmable logic controller is used to determine when the opening size on the choke should be changed. An advisory communication is preferably sent to a remotely located monitoring station advising that the opening size of the choke has been automatically adjusted. A decision is then made whether an operator should go to the well site and manually well test and shake out the well before placing the system on automatic operation again. The system includes monitors for monitoring well parameters, an automated choke which works in conjunction with a programmable logic controller to determine when to change the opening size of the choke, independent of human intervention, and a notification system to advise a remotely located monitoring station that changes have been to the opening size of the choke.

It is an object of the present invention to use an automated optimization well logic in conjunction with a PLC (programmable logic controller) to automatically adjust the opening size choke in a hydrocarbon producing well system, in response to sensed data or parameters from various sensors, without the need for direct intervention from a human operator for optimization while maintaining flow through the choke.

It is another object to provide a variety of sensors, including one or more downhole pressure sensors, which provide information to a PLC (programmable logic controller) which can, independent of human intervention, determine and effect whether to increase or decrease the size of an opening in a choke to provide real-time optimization of production from a hydrocarbon producing well.

### BRIEF DESCRIPTION OF THE DRAWINGS

These and other objects, features, and advantages of the present invention will become better understood with regard to the following description, pending claims, and accompanying drawings where:

FIG. 1 is a flow chart illustrating steps taken in conventional well optimization of chokes on well heads of wells which relies primarily upon human management and intervention;

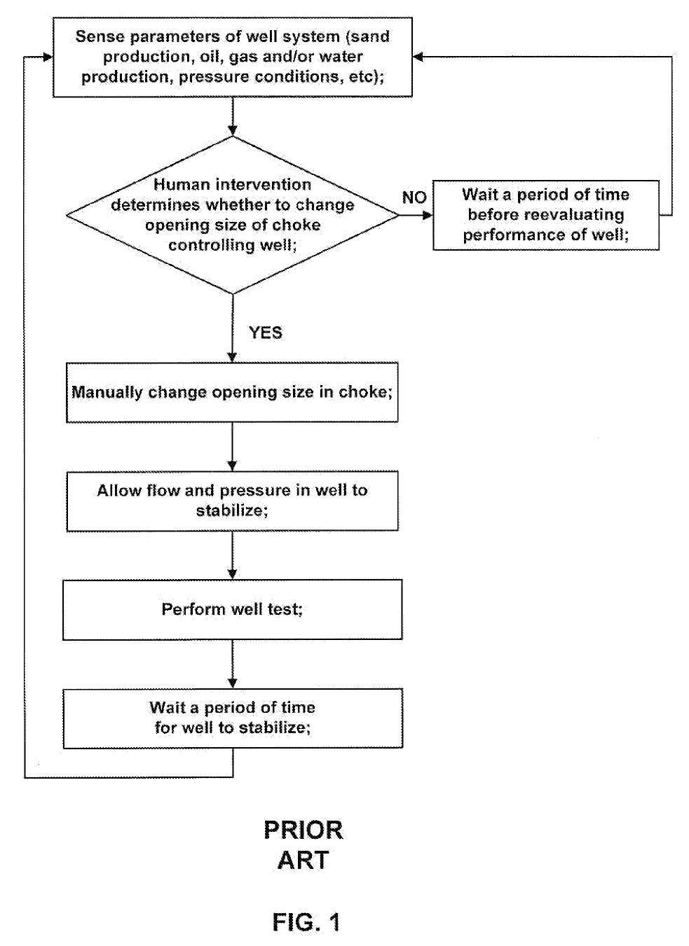

FIG. 2 is a schematic drawing of an exemplary embodiment of a well system showing a wellhead with a choke atop a wellbore and connected to a flow line leading to a separator. The choke is at least partially controlled by an automated well optimization logic which receives input from a variety of sensors in the well system;

FIG. 3 is a flow chart illustrating an embodiment, made in accordance with the present invention which includes the use of automated well optimization logic to control a choke on a well; and

FIG. 4 is a flow chart showing a particular embodiment of a variety of sensors which provide input to an automatic programmable logic (PLC) controller which determines whether to automatically open up or close down a choke while maintaining fluid flow from a hydrocarbon producing well.

### DETAILED DESCRIPTION OF THE DRAWINGS

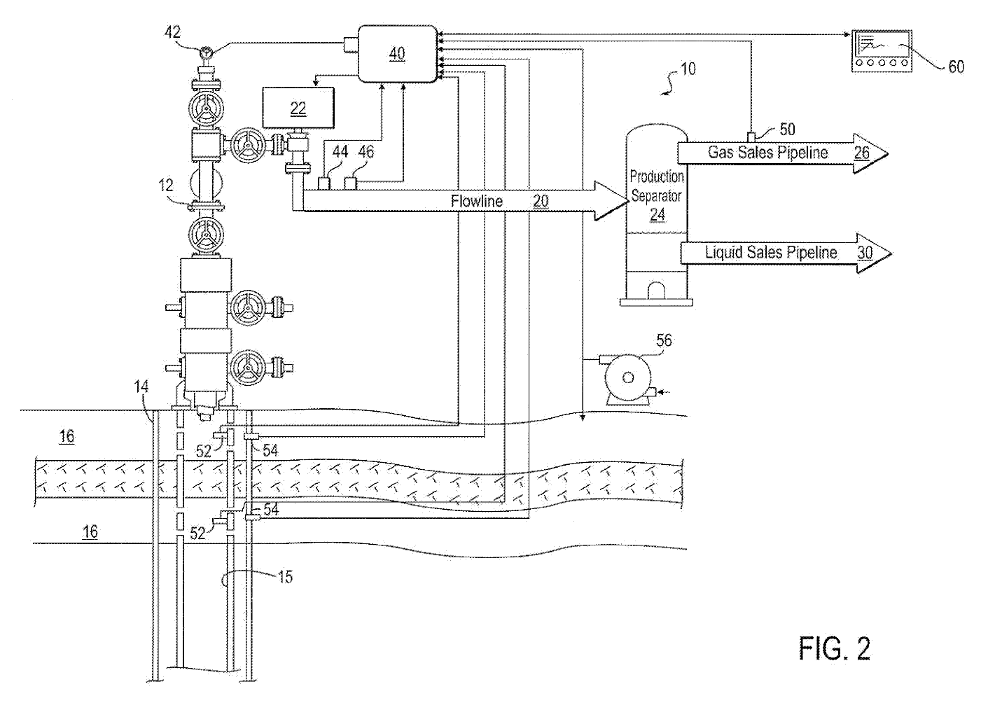

FIG. 2 shows a schematic drawing of a preferred embodiment, made in accordance with the present invention, of a well system 10. System 10 has a well head tree 12 mounted atop a well bore 14. Well bore 14 is in fluid communication with one or more subterranean reservoirs 16. Well head tree 12 is connected to a flow line 20 by way of an automated choke 22. Flow line 20 delivers fluids to a production separator 24 which separates production fluids produced from well bore 14 and reservoirs 16 into gas and liquid components. The gas components are passed to a gas sales pipe line 26 and liquids are sent to a liquids sales pipe line 30.

A number of sensors are used in well system 10 with the output from these sensors preferably being sent to a Programmable Logic Controller (PLC) 40. In response to these outputs, PLC 40 will automatically control the opening size of automated choke 22 and thus the relative rate of fluid flow through well head tree 12, the pressure within well bore 14 and the influx of sand from one or more reservoirs 16. Provisions, however are made that the automated choke 22 can be manually controlled when so desired such as when an operator is on site and decides to manually manipulate the opening size in the choke such as during well testing or when shaking out the well. Alternatively, although not preferred, well system 10 could be designed so that well testing and choking out the well might be controlled by a remotely located operator.

A tubing pressure sensor 42 is mounted atop well head tree 12 and measures the pressure within tubing 15 in the well head tree 42 upstream of automated choke 22. This well head tubing pressure measurement is provided to PLC 40. A flow line pressure sensor 44 is in fluid communication with and measures the pressure within flow line 20. This measurement of flow line pressure is communicated from flow line pressure sensor 44 to PLC 40. To assess the amount of sand flowing through flow line 20, and consequently produced from well bore 14 and reservoir(s) 16, a sand monitor sensor 46 is placed in fluid communication with flow line 20. An output signal from sand monitor sensor 46 is provided to PLC 40. In this preferred embodiments an optional gas meter 50, measuring the amount of flow in gas sales pipe line 26, is electronically connected to PLC 40 to provide a measure of the flow in gas sales pipe line 26. Of course, well system 10 could be fitted with additional sensors such as those that measure casing pressure in well bore 14.

Also, in this preferred embodiment, one or more downhole pressure sensors 52 are used to measure the pressure in downhole tubing 15 adjacent formations 16. Formation sensors 54 can be used determine the pressure in the formations proximate downhole tubing sensors 52. A pressure differential can then be determined by subtracting the measured pressure between formation sensors 54 and proximate downhole tubing pressure sensors 52. Alternatively, pressure supplied by a water flood injection pump 56 could be measured and the equivalent pressure is estimated as would otherwise be sensed by formation sensors 54. The downhole tubing pressure sensors 52 are particularly desirable in very deep wells such as those used in the Gulf of Mexico. For example, it may be desirable to utilize knowledge of the pressure differential between the downhole producing formation(s) 16 and the downhole tubing 15 near the producing formations 16.

A remote monitoring station 60 is in wired or wireless communication with PLC 40. The remote monitor may be located relatively close to the site of the well or else, for example in case of well systems in deep water/offshore locations, station 60 may be hundreds of miles away. If automated choke 22 is directed by PLC 40 to change its opening size, PLC 40 will send a signal to remote monitor 60 advising human personnel that such a change in the opening size has been made. Also, preferably the other sensor readings from the variety of sensors will ideally also be communicated to remote monitoring station 60 on a real time basis. A human, such as the operator, production supervisor or reservoir engineer, possibly located at the site of the remote monitor station 60 may determine that human intervention at the well site is not necessary for a particular opening size change. For example, this night be the case where a choke is being incrementally opened up to increase production from a gas well and little or no sand production is sensed and reported. In this case, production from the well bore 14 may be allowed to continue without personnel being dispatched to the well site for well tenting and well shake out.

However, if the operator determines that production from well system 10 needs to be checked with greater scrutiny and subsequent well tests and the shaking out of the well performed, then typically an operator will be sent to the well site to conduct such well tests and shake outs of the well.

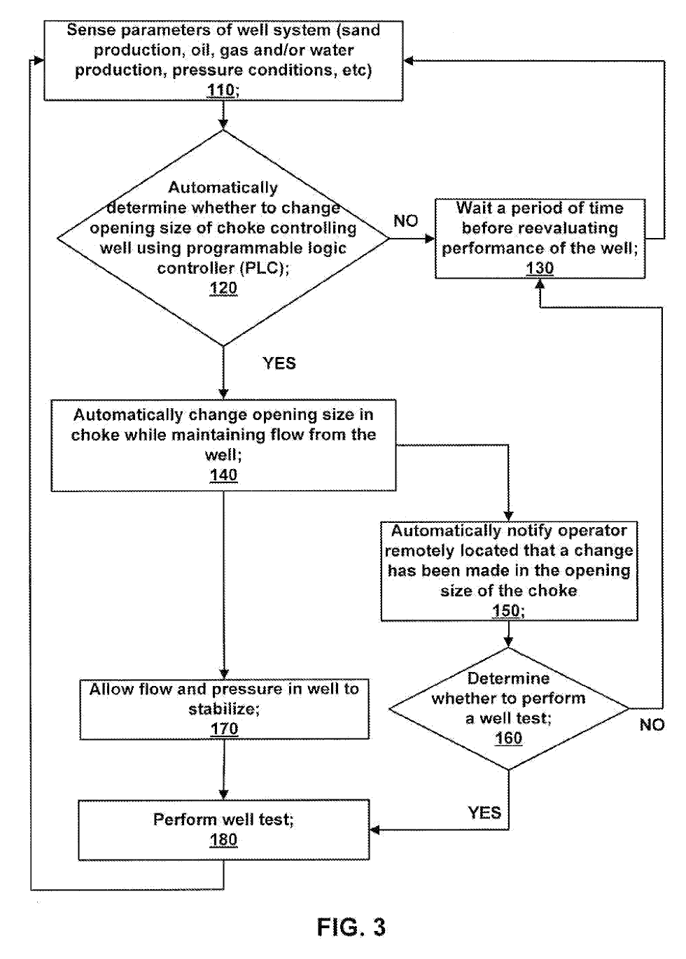

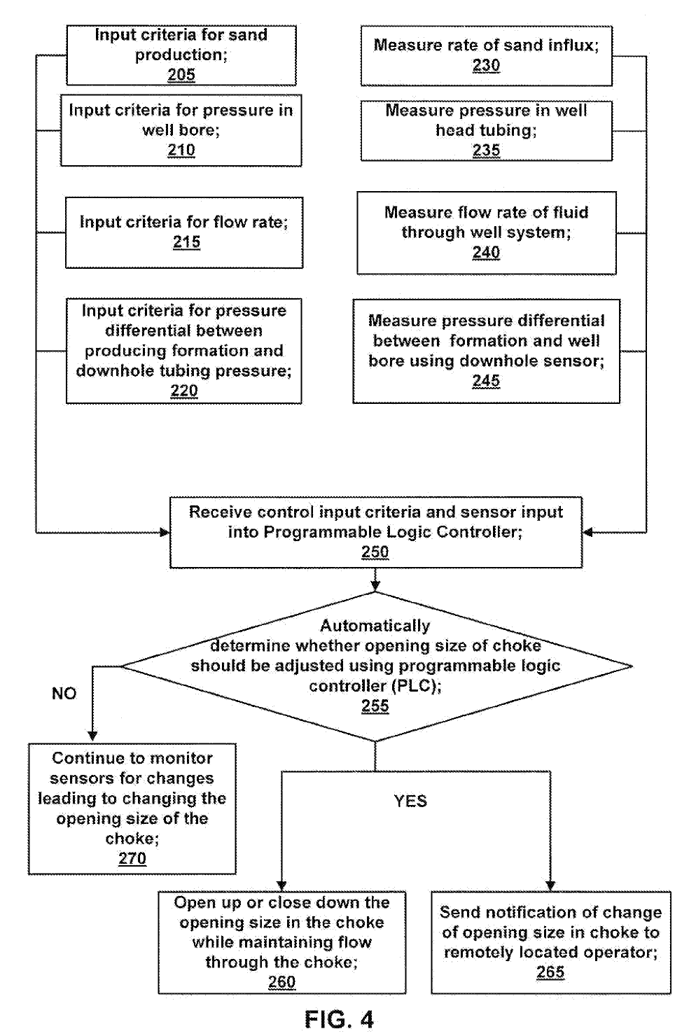

FIG. 3 shows a flowchart of steps taken in association with automatically controlling the opening size of choke 22. First, in step 110 a number of parameters are sensed such as those identified in FIG. 2. A programmable logic controller (PLC) 40 receives the sensed parameters and automatically determines in step 120 whether to change the opening size of choke 22 controlling well system 10. The logic associated with controller 40 will be described in greater detail below in conjunction with FIG. 4. If it is determined that no change is in order, then a waiting period of time is permitted in step 130 before another evaluation of sensed parameters is necessary. This wait period may be microseconds if continuous real-time monitoring is to take place. Alternatively, the wait period might be set to as tongs several days. In any event, it would be highly undesirable to have the wait period extended to a week, months or even a year before another evaluation is conducted as to whether to change the size of the opening of choke 22. These long waiting periods are common with conventional well management practices used today.

If sensed parameters of a well system 10 dictate that the PLC open up or close down the opening size on choke 22, in accordance with the programmed logic, automated choke 22 has its opening size changed in step 140 without human intervention unless manually overridden. If a change in opening size of choke 22 is made then an automatic notification is sent to remote monitoring station 60 in step 150. At remote monitor station 60, ideally an operator can determine in step 160 whether or not to instruct well system 10 to perform a well test in response to the automatic notification. In any event, in step 170 fluid is allowed to flow at its new rate and pressure in well system 10 for a period of time. This waiting period is often on the order of 48 hours and allows the well system 10 to stabilize in response to the change in the opening size of the choke and associated change in pressure in well bore 14. If no well test is to be conducted, then a waiting period may be provided, as in step 130, before sensed parameters in step 110 are again provided to PLC 40 in step 120 for further evaluation.

If a well test is to be performed in step 180, the test might be ordered from remote station 60. In this case, an automatic well test system (not shown in FIG. 2), will need to be incorporated in well system 10. More preferably, however, an on-site operator will manually conduct well tests and shake out the well system 10 with step 120 of automatically changing the opening size being overridden as human intervention is then preferred with operator being on-site as a result of the choke change and the automatic notification.

FIG. 4 shows a flowchart of the operation of one preferred embodiment for the operation of the programmable logic controller (PLC) 40. In steps 205, 210, 215 and 220, respective, input criteria is input for making changes to the opening size of choke 22 based upon sand production, pressure in the wellhead tubing 15, flow rate criteria, and pressure differential between the downhole producing formations 16 and downhole tubing 14. Also input into PLC 40 are sensed measures of rate of sand influx, step 230, the measure of pressure in well head tubing, step 235, the measure of the flow rate of fluid through the flow line 20, step 240, and the measured pressure differential between the downhole formation 16 and the downhole tubing in step 245.

A first parameter which may be monitored is the relative flow rate of sand through well system 10 and, in particular, choke 22. In this particular exemplary embodiment, the sand monitor sensor is preferably a Sandlog™ sensor available from CorrOcean of Houston, Tex. This monitor operates using an erodable probe to sense the erosion of a probe. The erosion of the probe increases electrical resistance of sensing elements. Sand erosion rates are determined by comparing sand erosion rates against time. Of course other alternative sand probes/monitors may be used if they can provide a reasonable measurement of relative rate or amount of sand passing through well system 10.

With respect to the governing input criteria for sand production, the sand rate average shut down set point might be set at 2,024 nV, in this preferred exemplary embodiment. For example, if the current instantaneous sand rate value is 1,882 nV (nano Value) and sand rate average is 1,840 nV, the set point would be set at 2,024 or 10% above the average. When this set point of 2,024 is reached, PLC 40 will order choke 22 to automatically close down one size and send the advisory message to remote monitoring station 60 that choke 22 has closed, for example, from an opening size of 31/64^{th} to an opening size of 30/64^{th}. A decision should then be made as to whether the operator should “shake out” well system 10 to insure that the system is operating within desired parameters and conditions or whether no well test and/or shake out is currently necessary.

The pressure criteria for the tubing pressure in the well head tree 12 may have a minimum pressure set point which is set at 20 psi above the nominal tubing pressure. For example, if the tubing pressure is 4000 psi, then the tubing minimum set point is set at 4020 psi. This arrangement allows the PLC to stop optimizing while still allowing a margin of error to keep fluids flowing through well system 10. A tubing draw down set point is set at 20 psi in this preferred exemplary embodiment. In this manner, when the average tubing pressure drops 20 psi, automated choke 22 will automatically increase the opening size of choke 22 1 size ( 1/64 inch), allowing for enhanced flow through well system 10. Again, a message is sent to the remote station 60 advising personnel that automated choke 22 has been opened from an initial opening size of 30/64^{th} that a slightly larger opening size of 31/64^{th} and that appropriate action (i.e., well test and shake out) should be considered.

If well system 10 incorporates gas meter 50, then a flow rate control option of the controlling PLC program is preferably set at a rate such as 10 Mmcf (million cubic feet). The program is set to allow the well to fluctuate 1 Mmcf up or down before changing the size of the opening in automated choke 22 to respectively decrease or increase the size of the opening of choke 22. Again, if flow sensor 50 senses this predetermined change in flow rate, an automatic change will be made in choke 22 and an advisory notification sent to the remote monitoring station 60.

As an example, downhole formation pressure may be at 5000 psi as measured by one of the downhole sensors 54, or else as calculated knowing the water flood injection pressure. The pressure measured by a corresponding downhole tubing sensor 52 may be at 4000 psi. If this pressure differential changes by more than 200 psi, the programmable logic will cause the choke to open up or close down the automated choke 22 by one size, i.e. 1/64 inch. Again, an advisory notification is sent to remote station 60.

In operation, automated choke 22 is opened to allow fluid (i.e. a mixture of oil and/or gas and water) to flow from shut-in well bore 14. For example, automated choke 22 may initially having an opening size of 30/64th. A 4 hour start up timer (ideally contained within PLC 40) is initialized allowing the pressure and flow rate in well bore 14 to stabilize, Concurrently, PLC 40 starts to collect data such as sand production rate data, well head tubing pressure data, gas flow rate data and downhole pressure differential data. Parameters are sensed and PLC 40 maintains the opening size of choke 22 until one of the controlling criteria is met and then PLC 40 orders choke 22 to appropriately open up or close down in size.

Once choke 22 has been changed in opening size, a stabilization timer will start and time down for a period of time, for example, 48 hours. During this time a “test and shake out well” notification will ideally flash on the remote control panel 60 until acknowledged. The logic program associated with PLC 40 will also start recalculating data averages. The automated choke 22 will not move until the timer has timed out (i.e. after 48 hours) and acknowledgement of the choke change has been provided by the operator. If any of the set points are hit, the PLC will place well system 10 in manual mode and a notification will be provided that the well optimization is now in manual mode. At any time the operator may place the program in manual mode. If a hurricane timer (not shown) is activated, the program will automatically go back to the manual mode.

By monitoring the flow line pressure and setting a low flow line set point, the optimization logic or program will preferably automatically go to a manual mode when the set point is reached. Example if the flowing tubing pressure is 1,050 psi and the flow line pressure is 1,000 psi and the flow line low set point is set at 1,020 psi (the program will automatically go to the manual mode) to allow the well to keep flowing until an operator decides to change pressure systems. This process can be repeated through all 3 pressure systems, high, intermediate and low until the choke is fully open.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention.

What is claimed is:

1. A method for controlling the flow of fluid through a wellhead of a hydrocarbon producing well system, the method comprising:
(a) sensing at least one parameter related to the flow of fluid through the wellhead, the wellhead including a choke which has an opening which is adjustable in size to control the rate of flow through the wellhead;
(b) automatically adjusting the size of the opening in the choke in response to the at least one sensed parameters while continuing to allow fluid to flow through the choke; and
(c) sending an advisory communication to a remotely located monitoring station advising that the opening size of the choke has been automatically adjusted.

2. The method of claim 1 further comprising:
(d) determining whether the opening size of the choke needs to be further manually adjusted by a human operator; and
(e) manually adjusting the opening size of the choke if it is determined that the opening size of the choke needs to be manually adjusted.

3. The method of claim 1 wherein:
the parameters measured include at least one of sand flow rate, pressure in the wellhead, the rate of flow of fluid through the choke, the
rate of gas flow through the choke and downhole pressure differential between downhole tubing and a downhole production formation.

4. The method of claim 1 wherein:
the downhole pressure differential is determined using measured downhole tubing pressure and measured down hole formation pressure in an adjacent producing formation.

5. The method of claim 1 wherein:
the downhole pressure differential is determined using a measured downhole tubing pressure and a calculated downhole formation pressure in an adjacent producing formation.

6. The method of claim 1 wherein:
the well system includes a flow line fluidly connected to the choke; and
if the flow line pressure reaches a predetermined set point, the automated choke will go into a manual mode wherein no more changes to the choke will occur automatically.

7. A well system for producing hydrocarbon containing fluids, the well system comprising:
a subterranean reservoir capable of producing hydrocarbon containing fluids;
a well head tree including an automated choke, the automated choke including programmable logic controller for automatically controlling the opening size in the choke in response to at least one sensed parameter of the well system;
a well bore and tubing which fluid connects between the subterranean reservoir and the well head tree;
a flow line in fluid communication with and downstream from the automated choke;
at least one sensor for sensing a parameter of the well system including at least one of sand flow rate through the automated choke and pressure upstream from the automated choke and pressure downstream from the automated choke and fluid flow through the automated choke, and a pressure differential between the tubing and the well bore proximate the reservoir; and
a remote monitoring station;
wherein the programmable logic automatically (PLC) controls the increasing and decreasing of the size of the choke opening in response to the at least one sensed parameter and independent of human intervention and which can send advisory notifications to the remote monitoring station that the PLC has automatically changed the opening size of the choke.

8. An automatic well control system for a hydrocarbon producing well, the automatic well control system comprising:
at least one sensor monitoring well parameters of a hydrocarbon producing well system;
an automated choke having hydrocarbon containing fluids flowing there through, the automated choke having a programmable logic controller which automatically changes the opening size of the choke in response to input from the at least one sensor, independent of human intervention and while fluid flow is maintained through the automated choke; and
a notification system which notifies a remotely located monitoring station when changes have been to the opening size of the automated choke.
